(19) United States
(12) Patent Application Publication
(10) Pub. No.: US 2018/0003468 A1
(43) Pub. Date: Jan. 4, 2018

(54) VEHICLE HATCH SYSTEM, AN AIRCRAFT EMPLOYING SAME AND METHOD OF ARMORING A HATCH OF A VEHICLE

(71) Applicant: Sikorsky Aircraft Corporation, Stratford, CT (US)

(72) Inventors: Nancy Held-Sheehe, Bethany, CT (US); Gerald Sheehe, Bethany, CT (US)

(21) Appl. No.: 15/543,463

(22) PCT Filed: Jan. 26, 2016
(86) PCT No.: PCT/US16/14861

§ 371 Date: Jul. 13, 2017

Related U.S. Application Data
(60) Provisional application No. 62/109,275, filed on Jan. 29, 2015.

(51) Int. Cl. F41H 5/26; F41H 5/04; B64D 7/00

(52) U.S. Cl. CPC F41H 5/263; B64D 7/00; F41H 5/0407

(57) ABSTRACT

A vehicle hatch system includes, a frame defining a perimeter of a hatch that is releasably attachable to a hatchway of a vehicle, at least one sub-frame attached to the frame configured to allow replaceable panels to be attached to the at least one sub-frame and the frame, at least one transparent non-armor panel is replaceably attachable to the at least one sub-frame and the frame, and at least one armor panel that is replaceably attachable to the at least one sub-frame and the frame.

### BACKGROUND OF THE INVENTION

Ballistic panels or plates are often added to vehicles, such as rotary wing aircraft, for example, to protect the occupant from projectiles such as live fire directed through transparencies (e.g., windows) or other non-transparent, non-protective structure (such as airframe skins). When added beside cockpit seats, the plates are often also referred to as “wing armor.” Due to their protective role, these panels and their supportive systems must be sufficiently robust to block a significant number of projectiles (e.g., rounds) at speed.

Rotary wing aircraft cockpit configurations also often include egress hatchways adjacent to pilot and co-pilot seats to allow occupants a secondary means of egress in side-by-side configurations (those where a central companionway out of the cockpit and into the cabin exists). Under certain circumstances, that primary pathway out of the cockpit may be blocked. In other rotary wing aircraft cockpit configurations, the cockpit hatchway may be the only way into and out of the cockpit.

In conventional configurations, ballistic panel coverage area and effective egress area provided through a neighboring hatchway work against each other. A large ballistic panel or wing armor plate will provide greater protection to the occupants when experiencing live fire, but that protection will likely come at the expense of hindered egress from and movement within the cabin. Conversely, large transparencies (e.g., windows) or areas without robust structure facilitate movement but may offer little to no ballistic protection. Arrangements and methods that allow for these competing criteria to coexist are of interest to those who practice in the art.

### BRIEF DESCRIPTION OF THE INVENTION

Disclosed herein is a vehicle hatch system. The system includes, a frame defining a perimeter of a hatch that is releasably attachable to a hatchway of a vehicle, at least one sub-frame attached to the frame configured to allow replaceable panels to be attached to the at least one sub-frame and the frame, at least one transparent non-armor panel is replaceably attachable to the at least one sub-frame and the frame, and at least one armor panel that is replaceably attachable to the at least one sub-frame and the frame.

Further disclosed herein is an aircraft. The aircraft includes a fuselage and a hatchway of the fuselage that is receptive to a hatch in accordance with the vehicle hatch system discussed above.

Further disclosed herein is a method of armoring a hatch of a vehicle. The method includes, selecting a prefabricated transparent non-armor panel from a selection of prefabricated transparent non-armor panels, attaching the selected prefabricated transparent non-armor panel to a frame and a sub-frame of a hatch, wherein the hatch is attachable to a hatchway of a vehicle, selecting a prefabricated armor panel from a selection of prefabricated armor panels, and attaching the selected prefabricated armor panel to the frame and the sub-frame of the hatch.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a side view of a portion of an aircraft employing the vehicle hatch system disclosed herein;

FIG. 2 depicts a perspective view of the vehicle hatch system of FIG. 1 as viewed from an opposite side to the view of FIG. 1;

FIG. 3 depicts a side view of a portion of an aircraft employing an alternate embodiment of the vehicle hatch system discloses herein;

FIG. 4 depicts a perspective view of the vehicle hatch system of FIG. 3 as viewed from an opposite side to the view of FIG. 3; and

FIG. 5 depicts a partial side view of an aircraft employing the vehicle hatch system of FIG. 3.

### DETAILED DESCRIPTION OF THE INVENTION

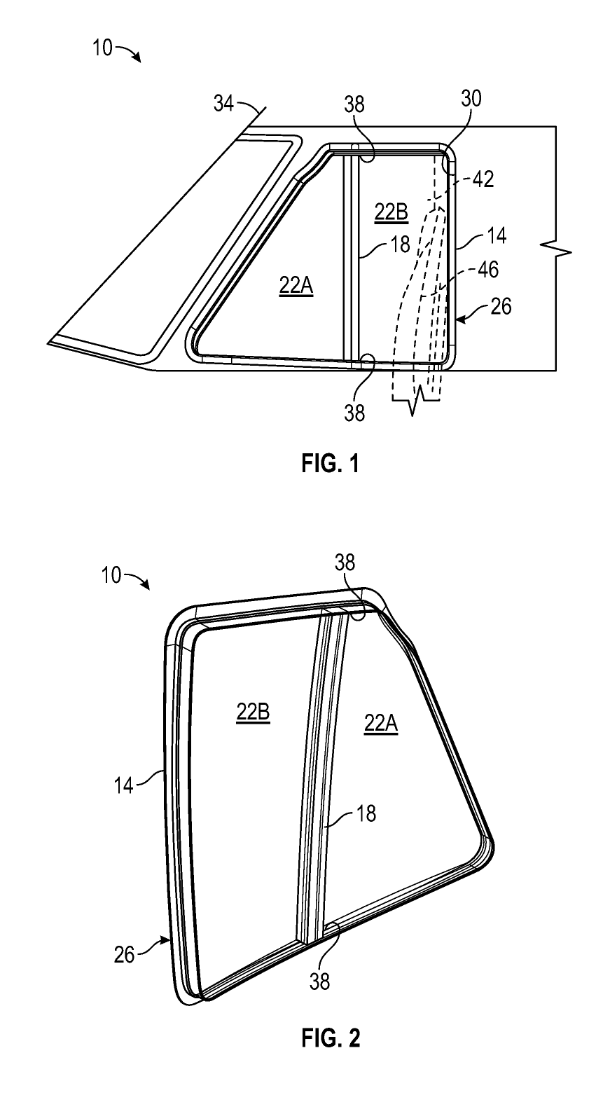

Referring to FIGS. 1 and 2, an embodiment of a vehicle hatch system 10 disclosed herein includes a frame 14, at least one sub-frame 18, with just one being shown in FIG. 1, and at least two replaceable panels 22A, 22B, with two of the panels being shown. The frame 14 defines a perimeter of a hatch 26 that is releasably attachable to a hatchway 30 of a vehicle 34, illustrated herein as an aircraft and more specifically as a helicopter. The sub-frame 18 is attached to the frame 14 at opposing ends 38 thereof. The frame 14 and the sub-frame 18 are configured to allow the replaceable panels 22A, 22B to be detachably attached to the at least one sub-frame 18 and the frame 14. In this embodiment one of the panels 22A is a transparent non-armor panel and the other of the panels 22B is an armor panel, although both or either of the panels 22A, 22B could be transparent non-armor panels and/or armor panels. The armor panel 22B in the illustrated embodiment is configured to prevent rounds fired at the vehicle 34 that impinge the panel 22B from passing therethrough thereby protecting a person or persons within a cockpit 42 of the vehicle 34 from being hit by the rounds.

The panels 22A, 22B are replaceably attachable to the frame 14 and the sub-frame 18. This allows a mission planner to select panels 22A, 22B, for example, from a plurality of prefabricated panels 22A, 22B, to be attached to the hatch 26 based on a mission's potential for encountering live combat. If, for example, no live combat is anticipated in a mission the mission planner may elect to employ transparent non-armor panels for both the panels 22A, 22B. If, on the other hand, live combat is anticipated during a mission, the mission planner may elect to have one or both of the panels 22A, 22B be armor panels. Since the panels 22A, 22B are replaceable they can be changed as desired to match the needs of each mission. It should be understood that armor panels may be opaque or they may also be transparent without deviating from the invention disclosed herein.

The frame 14, sub-frame 18 and panels 22A, 22B are configured such that when assembled together they form the hatch 26. The hatch 26 with the components (the frame 14, sub-frame 18 and panels 22A, 22B) may remain assembled together whether the hatch 26 is attached to or completely removed from the hatchway 30 of the vehicle 34. This allows for quick unrestricted egress from the cockpit 42 through the hatchway 30 when the hatch 26 is open or removed from the vehicle 34. As such, the hatch 26 can be jettisoned from the vehicle 34 during an emergency, for example, without altering the jettison operation or vehicular hardware that is employed in vehicles that do not employ the hatch system 10 disclosed herein.

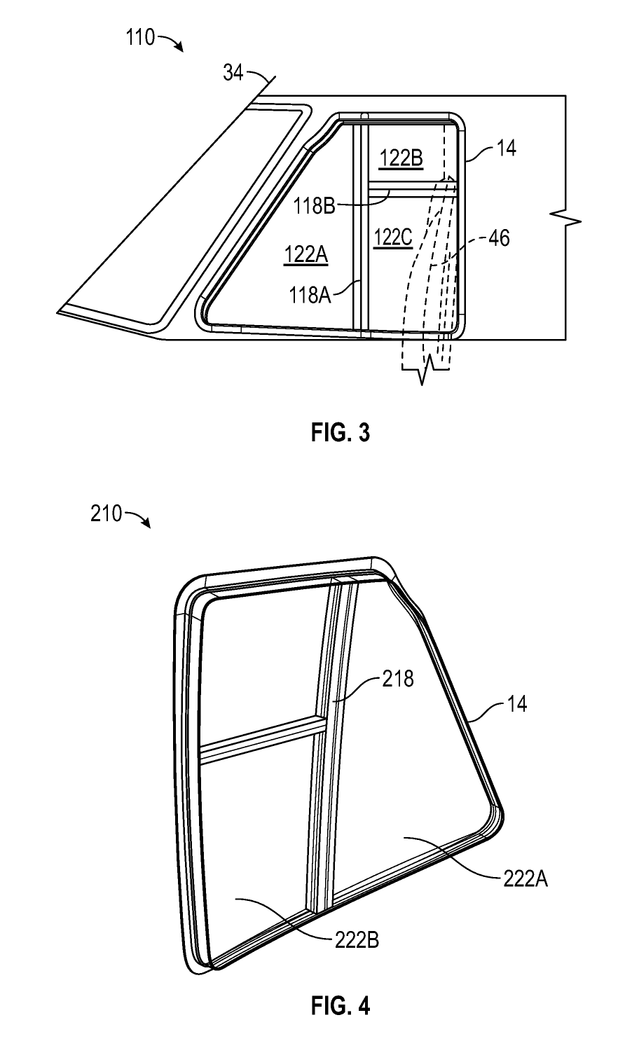

Referring to FIG. 3, another embodiment of a vehicle hatch system 110 with similarities to the vehicle hatch system 10 is shown. Wherein the elements of the system 10 are substantially unchanged from the system 110 the same reference characters are employed and detailed descriptions are not repeated hereunder. The system 110 includes the frame 14, and sub-frames 118A, 118B. The two sub-frames 118A, 118B divide the area defined within the frame 14 into three sections instead of two sections as was the case in the system 10. As such, three panels 122A, 122B and 122C are employed in the system 110. The panels 122A, 122B, 122C can be selected from a plurality of prefabricated panels 122A, 122B, 122C. Additionally, each of the panels 122A, 122B, and 122C can be either transparent non-armor or armor. Employing the three panels 122A, 122B, 122C, instead of just two as in the system 10, allows for greater customization by a mission planner since different levels of protection can be provided by selecting which of the panels 122A, 122B, and 122C are armor and which are not. For example, in embodiments wherein armor panels are opaque, employing transparent non-armor panels for 122A, and 122B and an armor panel for 122C can provide increased visibility to a pilot in the seat 46 than if the panel 122B were made of an opaque armor material.

Referring to FIG. 4, yet another embodiment of a vehicle hatch system disclosed herein is illustrated at 210. The system 210 employs a sub-frame 218 that is positioned inboard (that is on the cockpit 42 side) of a transparent non-armor panel 222A that spans the complete area defined by the frame 14. A separate panel 222B, also positioned inboard of the panel 222A, is structurally supported by the frame 14 and the sub-frame 218. In one embodiment the panel 222B is armor and the panel 222A is transparent non-armor, although any combination of transparent non-armor and armor can be employed in the panels 222A and 222B as discussed above in regards to the other embodiments. Optionally, the sub-frame 218 instead of being inboard of the panel 222A could effectively bisect the area defined by the frame 14 into separate areas to be filed by panels in a fashion similar to that of FIGS. 1 and 2, while still allowing the panel 222B to be positioned inboard of the panel 222A that is aligned with the frame 14.

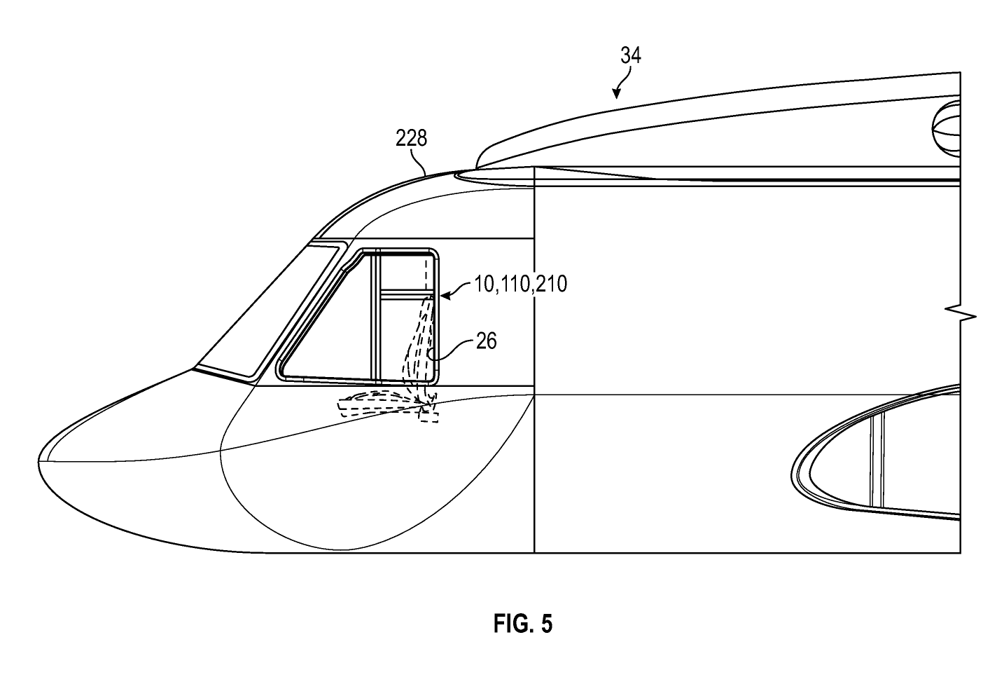

Referring to FIG. 5 a vehicle 34 is illustrated employing the vehicle hatch system 210 disclosed herein. While the vehicle 34 in this embodiment is a helicopter it should be understood that the vehicle 34 could be any means of transportation that could benefit from the invention disclosed herein. The helicopter 34 includes a fuselage 228 that defines the hatchway 30 within which the hatch 26 in accordance with any of the vehicle hatch systems 10, 110, 210 disclosed herein is employable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A vehicle hatch system, comprising:
a frame defining a perimeter of a hatch that is releasably attachable to a hatchway of a vehicle;
at least one sub-frame attached to the frame configured to allow replaceable panels to be attached to the at least one sub-frame and the frame;
at least one transparent non-armor panel being replaceably attachable to the at least one sub-frame and the frame; and
at least one armor panel being replaceably attachable to the at least one sub-frame and the frame.

2. The vehicle hatch system of claim 1, wherein the at least one armor panel is opaque.

3. The vehicle hatch system of claim 1, wherein the at least one armor panel is configured to prevent rounds that impinge upon the at least one armor panel from contacting a body of a person within a vehicle employing the vehicle hatch system that are on a trajectory to contact the person.

4. The vehicle hatch system of claim 1, wherein a hatch, including the frame, the at least one sub-frame and any releasable panels attached to the frame and sub-frame are completely removable from the hatchway of the vehicle as an intact assembly.

5. The vehicle hatch system of claim 1, wherein a hatch of the vehicle hatch system is completely removable from the vehicle during a jettison procedure.

6. The vehicle hatch system of claim 1, wherein a hatch of the vehicle hatch system is completely removable from the vehicle.

7. The vehicle hatch system of claim 1, wherein the at least one sub-frame is two sub-frames that permit three separate replaceable panels to be attached to the frame and the two sub-frames.

8. The vehicle hatch system of claim 1, wherein the replaceable panels are prefabricated and can be selectively attached to the frame and sub-frame in preparation for each mission for which the vehicle is to be employed.

9. The vehicle hatch system of claim 1, wherein the at least one armor panel is attached to the frame and the at least one sub-frame inboard of a transparent non-armor panel that is also attached to the frame and the at least one sub-frame.

10. A method of armoring a hatch of a vehicle, comprising:
selecting a prefabricated transparent non-armor panel from a selection of prefabricated transparent non-armor panels;
attaching the selected prefabricated transparent non-armor panel to a frame and a sub-frame of a hatch, the hatch being attachable to a hatchway of a vehicle;
selecting a prefabricated armor panel from a selection of prefabricated armor panels; and
attaching the selected prefabricated armor panel to the frame and the sub-frame of the hatch.

11. The method of armoring a hatch of a vehicle of claim 10, further comprising attaching the hatch to the hatchway of the vehicle.

12. An aircraft comprising:
a fuselage; and
a hatchway of the fuselage being receptive to a hatch in accordance with the vehicle hatch system of claim 1.
